(19) United States
(12) Patent Application Publication
(10) Pub. No.: US 2026/0246399 A1
(43) Pub. Date: Aug. 20, 2026

(54) DYNAMIC BRAKE DEVICE

(71) Applicant: FANUC CORPORATION, Minamitsuru-gun, Yamanashi (JP)

(72) Inventor: Daishi GOTOU, Minamitsuru-gun, Yamanashi (JP)

(73) Assignee: FANUC CORPORATION, Minamitsuru-gun, Yamanashi (JP)

(21) Appl. No.: 19/161,739

(22) PCT Filed: Mar. 13, 2023
(86) PCT No.: PCT/JP2023/009657

§ 371 Date: Sep. 3, 2025

(51) Int. Cl. H02P 3/22

(52) U.S. Cl. CPC H02P 3/22

(57) ABSTRACT

Provided is a dynamic brake device having a structure in which vibration of a switch part is not easily transmitted to a resistance part. This dynamic brake device is connected between a motor, and a motor drive device that drives the motor. The dynamic brake device comprises: a resistance unit that is attached to a first attachment surface and converts rotational energy of the motor into thermal energy; and a switch unit that is attached to a second attachment surface and switches the flow direction of current so as to cause a short circuit between the terminals of the motor via the resistance part. The first attachment surface and the second attachment surface are not positioned on the same plane.

### TECHNICAL FIELD

The present invention relates to a dynamic brake device.

### BACKGROUND ART

A dynamic brake device may be provided between a motor used for driving each axis of a machine tool, etc., and a drive device for driving the motor. The dynamic brake device shorts terminals of the motor via a resistor and converts rotational energy of the motor into thermal energy for consumption, thereby quickly stopping the motor (e.g., see Patent Literature 1 to 3).

In addition, the dynamic brake device may be provided with an electromagnetic contactor as a switch for switching the direction of current flow. As a vibration-proofing measure for the electromagnetic contactor, a technique of providing an elastic body in a housing for the electromagnetic contactor is well known (e.g., see Patent Literature 4).

### CITATION LIST

### Patent Literature

[PTL 1] JP 2017-060402 A

[PTL 2] JP 1995(H07)-222456 A

[PTL 3] JP 2021-016224 A

[PTL 3] JP 2010-170932 A

### SUMMARY OF INVENTION

### Technical Problem

FIG. 10 shows a dynamic brake device 100 according to the prior art, with its housing omitted for clarity. The dynamic brake device 100 has a resistor unit 102 such as a cement resistor, and an electromagnetic contactor 104, wherein the resistor unit 102 and the electromagnetic contactor 104 are mounted on the same mounting surface (mounting plate) 106. In other words, the resistor unit 102 and the electromagnetic contactor 104 are provided on the same plane.

In general, a mechanical switch such as an electromagnetic contactor used in a dynamic brake device tends to be largely vibrated when activated. When the resistor unit 102 and the electromagnetic contactor 104 are on the same plane as shown in FIG. 10, the vibration of the electromagnetic contactor 104 are easily transmitted to the resistor unit 102, which may damage the resistor unit 102. Therefore, a dynamic brake device having a structure which makes it difficult for the vibration of a switch unit such as a mechanical switch to be transmitted to the resistor unit is desired.

### Solution to Problem

One aspect of the present disclosure provides a dynamic brake device connected between a motor and a motor drive device for driving the motor, the dynamic brake device comprising: a resistor unit attached to a first attachment surface and configured to convert rotational energy of the motor to thermal energy; and a switch unit attached to a second attachment surface and configured to switch a flow direction of a current so that terminals of the motor are short-circuited via the resistor unit, wherein the first attachment surface and the second attachment surface are not positioned on the same plane.

### BRIEF DESCRIPTION OF DRAWINGS

FIG. 1 is a schematic configuration view of a system including a dynamic brake device according to an embodiment.

FIG. 2 is a schematic configuration view showing a state in which a flow direction of a current is switched.

FIG. 3 is a schematic side view of a dynamic brake device according to a first example.

FIG. 4 is a schematic perspective view of the dynamic brake device of FIG. 3.

FIG. 5 is a schematic view of an internal structure of an electromagnetic contactor, showing contacts in an open state.

FIG. 6 is a view showing the contacts of the electromagnetic contactor are in a closed state.

FIG. 7 is a view showing suppression of vibration by a plate.

FIG. 8 is a schematic side view of a dynamic brake device according to a second example.

FIG. 9 is a schematic side view of a dynamic brake device according to a third example.

FIG. 10 is a schematic perspective view of a conventional dynamic brake device.

### DESCRIPTION OF EMBODIMENTS

FIG. 1 is a schematic configuration view of a motor system 2 including a dynamic brake device according to an embodiment. The motor system 2 includes a motor 4 such as a servomotor, a motor drive device 6 such as an amplifier for supplying power to the motor 4, and a dynamic brake device 10 connected between the motor 4 and the motor drive device 6 via a power lune 8, etc. The motor 4 is, for example, a synchronous motor configured to drive each axis of a machine tool or each axis of a robot.

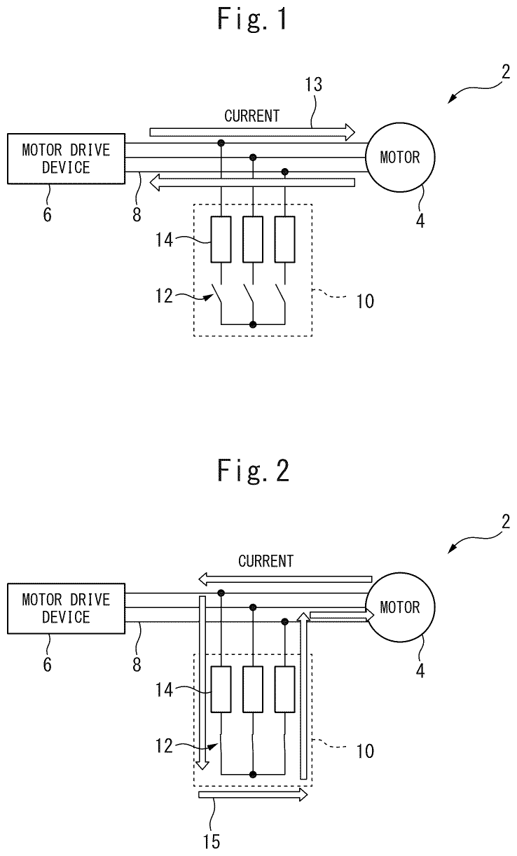

FIG. 2 shows a state in which a flow direction of a current has been switched in the system 2 of FIG. 1. Typically, as shown by an arrow 13 in FIG. 1, the current from the motor drive device 6 flows to the motor 4 without passing through the dynamic brake device 10. However, in the event of a power outage or emergency stop, a protection circuit (not shown) is activated so as to short-circuit terminals of the motor 4. Specifically, when a switch 12 of the dynamic brake device 10 is closed, the current flows through a resistor unit 14 as shown by an arrow 15, and the rotational energy of the motor 4 is consumed as heat, allowing the motor 4 to be stopped quickly.

The resistor unit 14 is typically a cement resistor including a brittle material, but the present disclosure is not limited thereto, and includes any resistor which may be damaged or broken by a relatively large vibration. The switch unit 12 is, for example, a mechanical switch such as an electromagnetic contactor, and includes a switch which may generate a certain amount of vibration by its operation.

### First Example

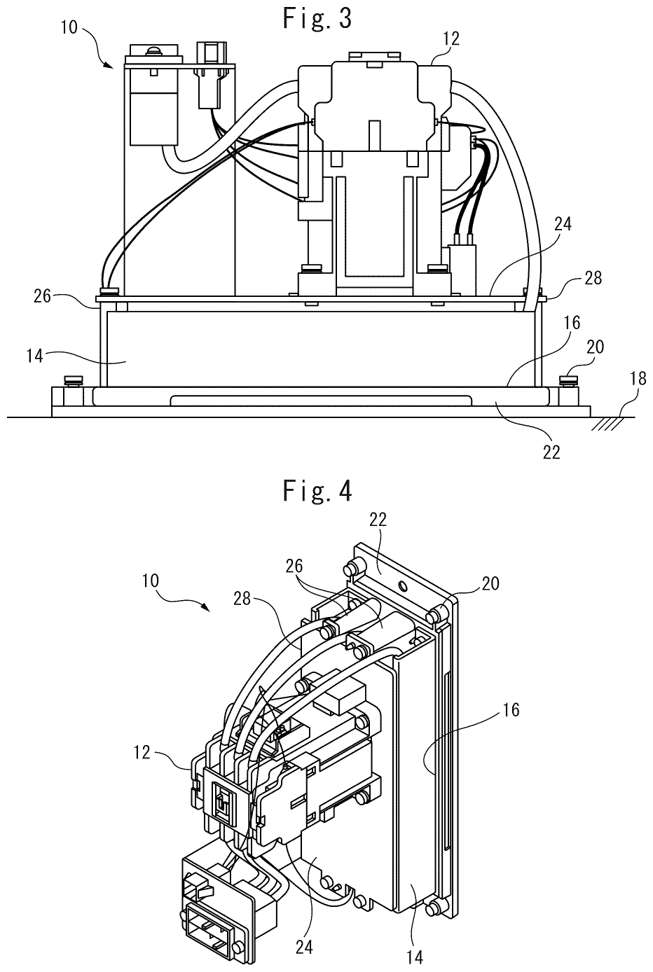

FIGS. 3 and 4 are a schematic side view and a schematic perspective view, respectively, of the dynamic brake device 10 according to a first example. The dynamic brake device 10 has a resistor unit 14 configured to convert rotational energy of the motor 4 to thermal energy, and a switch unit 12 configured to switch the flow direction of the current so that the terminals of the motor 4 are short-circuited via the resistor unit 14.

The resistor unit 14 is, for example, a cement resistor, includes a brittle material which is relatively easily damaged by vibration, etc., and is attached to a first attachment surface 16. The first attachment surface 16 is, for example, a surface of an attachment plate 22 fixed by a screw 20, etc., to a schematically shown attachment target 18 of the dynamic brake device 10.

On the other hand, the switch unit 12 is a mechanical switch such as an electromagnetic contactor, and is attached to a second attachment surface 24 which is not on the same plane as the first attachment surface 16. The second attachment surface 24 is, for example, a surface of a plate-like member 28 fixed to the attachment plate 22 by a support member 26 such as a screw or a boss.

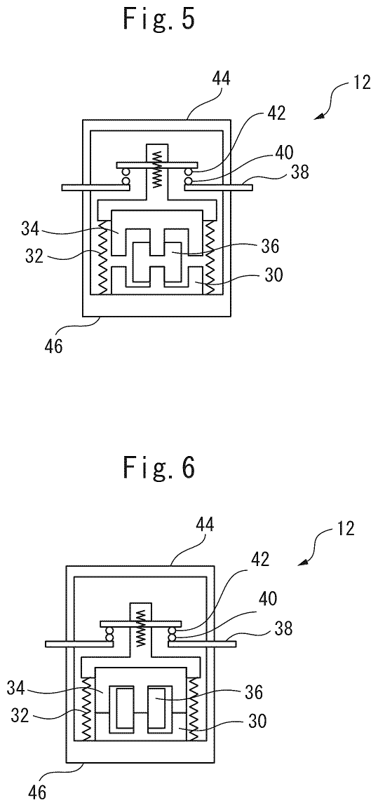

FIGS. 5 and 6 are schematic views of an example of an internal structure of the switch unit 12 as the electromagnetic contactor. The switch unit 12 has a fixed core 30, a movable core 34 supported by a spring 32 so as to be displaceable relative to the fixed core 30, and a coil 36 positioned between the fixed core 30 and the movable core 34. The switch unit 12 also has a terminal 38, a fixed contact 40 provided on the terminal 38, and a movable contact 42 provided on the movable core 34 and capable of contacting and separating from the fixed contact 40, wherein these elements are arranged in a housing 44. FIG. 5 shows a state in which no current flows through the coil 36 and the contacts are open, and FIG. 6 shows a state in which the contacts are closed by passing the current through the coil 36. In the electromagnetic contactor 12, a member (here, a lower part) 46 to which the fixed core 30 is attached is fixed or attached to the second attachment surface 24.

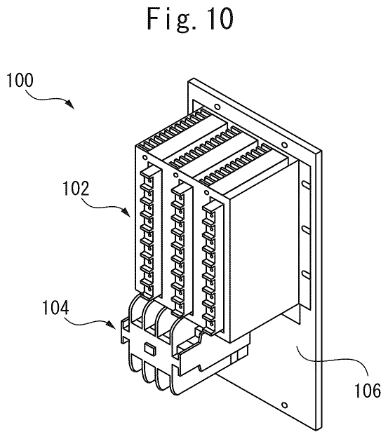

In the electromagnetic contactor 12, operations including opening and closing of the contacts are frequently performed, and these operations generate vibration in the contacting/separating direction (the up and down direction in FIGS. 5 and 6) of the contacts. In a conventional dynamic brake device, the electromagnetic contactor and the resistor unit are provided on the same plane as shown in FIG. 10, so the vibration of the electromagnetic contactor is easily transmitted to the resistor unit, and thus the resistor unit is easily damaged. In addition, there is a risk that pieces of the damaged resistor unit may enter the electromagnetic contactor, causing the electromagnetic contactor to malfunction.

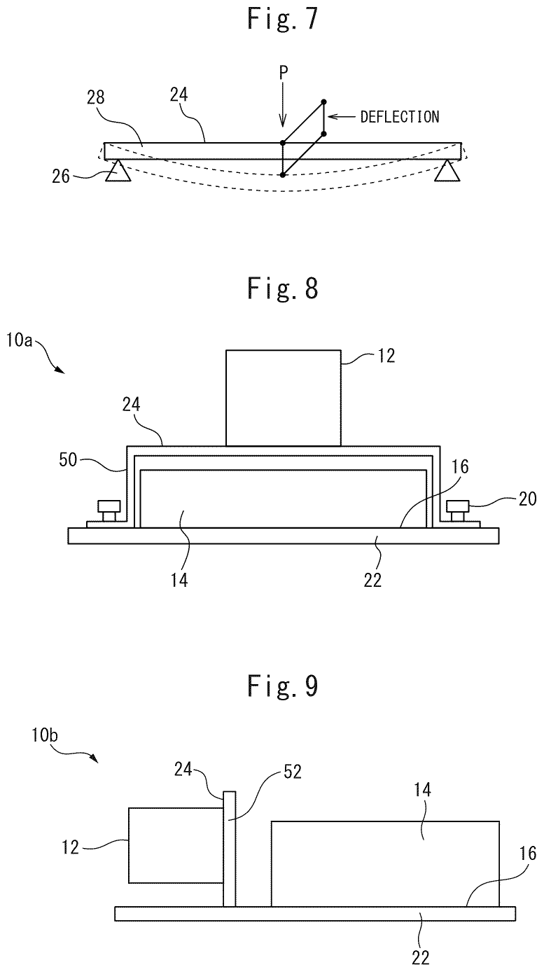

FIG. 7 is a view explaining the effect of the first example. As described above, the first attachment surface 16 to which the resistor unit 14 is attached and the second attachment surface 24 to which the switch unit 12 is attached are not located on the same plane. In other words, the dynamic brake device 10 has a stepped structure. Therefore, the plate-like member 28 having the second attachment surface 24 is supported at both ends by the bosses 26, etc., and deflects in the position and direction indicated by an arrow P due to vibration caused by the switch unit 12. This deflection reduces the impact and vibration to the switch unit 12, and significantly suppresses the vibration transmitted to the first attachment surface 16 (resistance unit 14), thereby preventing damage to the resistor unit 14.

The second attachment surface 24 is preferably positioned between the resistor unit 14 and the switch unit 12. By virtue of this positional relationship, it is easy to physically separate the switch unit 12 and the resistor unit 14, and it is difficult for vibration of the switch unit 12 to be transmitted to the resistor unit 14.

It is also preferable to configure the plate-like member 28 so as not to have any opening at least in the portion where the switch section 12 is attached. By virtue of this, even when the resistor unit 14 is broken, the plate-like member 28 also functions as a physical partition which prevents pieces of the resistor unit 14 from entering the switch unit 12, thereby preventing failure or malfunction of the switch unit 12 due to the pieces of the resistor unit 14.

The plate 28 is, for example, a metallic plate having a thickness and material which allows a certain amount of deflection to occur due to the vibration of the switch unit 12. Alternatively, the plate-like member 28 may be formed from an elastic member such as rubber. Alternatively or in addition, the support member 26, such as a boss which fixes the plate-like member 28 to the attachment plate 22, may be formed from an elastic member such as rubber. By having at least one of the second attachment surface 24 of the plate-like member 28 and the support member 26 be made of an elastic member such as rubber or an elastic structure, the vibration of the switch unit 12 can be more suitably absorbed and suppressed.

### Second Example

FIG. 8 is a schematic side view of a dynamic brake device 10a according to a second example. In the second example, components different from those of the first embodiment will be mainly described, and a description of components which may be the same as those of the first example will be omitted.

In the dynamic brake device 10a according to the second example, a stepped structure in which the first attachment surface 16 and the second attachment surface 24 are not on the same plane can be realized by substantially a single metallic sheet 50. In other words, the second example corresponds to an embodiment in which the second attachment surface 24 and the support member 26 in the first example are substantially formed by the single metallic sheet 50. For example, the single metallic sheet 50 is formed into a substantially U-shape in side view by bending, etc., and the metallic sheet 50 is fixed to the attachment member 22 by the screw 20, etc.

According to the second example, the structure in which the vibration of the switch unit 12 is unlikely to be transmitted to the resistor unit 14 can be realized with fewer parts than in the first example, and the cost of the dynamic brake device can be further reduced.

### Third Example

FIG. 9 is a schematic side view of a dynamic brake device 10b according to a third example. In the third example, components different from those of the first embodiment will be mainly described, and a description of components which may be the same as those of the first example will be omitted.

In the first and second examples, the first and second attachment surfaces are not on the same plane and are generally parallel to each other. On the other hand, in the third example, the first attachment surface 16 and the second attachment surface 24 are not on the same plane and are generally perpendicular to each other. For example, by fixing a plate-like member 52 to the attachment member 22 so that the surface direction of the plate-like member 52 is perpendicular to the surface direction of the attachment member 22, the first attachment surface 16 and the second attachment surface 24 can be made generally perpendicular to each other. Also, the member 46 (see FIG. 5 or 6) of the switch unit 12 such as the electromagnetic contactor is attached to the second attachment surface 24.

In the third example, even when the switch unit 12 vibrates, the plate-like member 52, one end of which is supported by (the first attachment surface 16 of) the plate-like member 22, functions as a so-called cantilever beam, so that the vibration is unlikely to be transmitted to the resistor unit 14. Therefore, also in the third example, damage to the resistor unit 14 due to the vibration of the switch unit 12 can be prevented.

Although the present disclosure has been described in detail, the present disclosure is not limited to the above-mentioned individual embodiments. Various additions, replacements, modifications, partial deletions, etc. are possible for these embodiments within the scope of the gist of the present disclosure, or within the scope of the gist of the present disclosure derived from the contents described in the claims and their equivalents. These embodiments can also be implemented in combination. For example, in the above-mentioned embodiments, the order of each operation and the order of each process are shown as examples, and are not limited to these. The same applies when numerical values or formulas are used in the description of the above-mentioned embodiments.

The following supplementary clauses are further disclosed regarding the above-described embodiment and modified examples.

### (Clause 1)

A dynamic brake device connected between a motor and a motor drive device for driving the motor, the dynamic brake device comprising: a resistor unit attached to a first attachment surface and configured to convert rotational energy of the motor to thermal energy; and a switch unit attached to a second attachment surface and configured to switch a flow direction of a current so that terminals of the motor are short-circuited via the resistor unit, wherein the first attachment surface and the second attachment surface are not positioned on the same plane.

### (Clause 2)

The dynamic brake device according to clause 1, wherein the second attachment surface is positioned between the resistor unit and the switch unit.

### (Clause 3)

The dynamic brake device according to clause 1 or 2, wherein the second attachment surface has an elastic member or an elastic structure.

### (Clause 4)

The dynamic brake device according to any one of clauses 1 to 3, further comprising a support member configured to support the second attachment surface.

### (Clause 5)

The dynamic brake device according to clause 4, wherein the support member has an elastic member or an elastic structure.

### (Clause 6)

The dynamic brake device according to clause 4, wherein the second attachment surface and the support member are made from one metallic sheet.

### (Clause 7)

The dynamic brake device according to clause 1 or 2, wherein the second attachment surface is a surface of a plate-like member having one end supported by the first attachment surface and capable of acting as a cantilever beam.

### REFERENCE SIGNS LIST

2 system
4 motor
6 motor drive device
8 power line
10, 10a, 10b dynamic brake device
12 switch unit
14 resistor unit
16 first attachment surface
18 attachment target
20 screw
22 attachment member
24 second attachment surface
26 boss
28, 52 plate-like member
40 fixed core
42 movable core
44 housing
50 metallic sheet

1. A dynamic brake device connected between a motor and a motor drive device for driving the motor, the dynamic brake device comprising:
a resistor unit attached to a first attachment surface and configured to convert rotational energy of the motor to thermal energy; and
a switch unit attached to a second attachment surface and configured to switch a flow direction of a current so that terminals of the motor are short-circuited via the resistor unit,
wherein the first attachment surface and the second attachment surface are not positioned on the same plane.

2. The dynamic brake device according to claim 1, wherein the second attachment surface is positioned between the resistor unit and the switch unit.

3. The dynamic brake device according to claim 1 or 2, wherein the second attachment surface has an elastic member or an elastic structure.

4. The dynamic brake device according to any one of claims 1 to 3, further comprising a support member configured to support the second attachment surface.

5. The dynamic brake device according to claim 4, wherein the support member has an elastic member or an elastic structure.

6. The dynamic brake device according to claim 4, wherein the second attachment surface and the support member are made from one metallic sheet.

7. The dynamic brake device according to claim 1 or 2, wherein the second attachment surface is a surface of a plate-like member having one end supported by the first attachment surface and capable of acting as a cantilever beam.
